(19) United States
(12) Patent Application Publication
(10) Pub. No.: US 2006/0083864 A1
(43) Pub. Date: Apr. 20, 2006

(54) Radiation curable hot melt composition and a process for the application thereof

(75) Inventors: Ann Kerstin B.K. Lindell, Malmo (SE); Klaas Jan H. Kruithof, Veenendaal (NL); Kent Raabjerg Sorensen, Perstorp (SE)

Correspondence Address: AKZO NOBEL INC.;INTELLECTUAL PROPERTY DEPARTMENT, 7 LIVINGSTONE AVENUE, DOBBS FERRY, NY, 10522-3408, US

(73) Assignee: AKZO NOBEL N.V., Arnhem (NL)

(21) Appl. No.: 11/296,146

(22) Filed: Dec. 7, 2005

Related U.S. Application Data
(62) Division of application No. 09/692,303, filed on Oct. 19, 2000.

(30) Foreign Application Priority Data
Oct. 19, 1999 (EP) 99203431.4

(51) Int. Cl. C08J 3/28; C08F 2/48

(52) U.S. Cl. 427/508; 522/111

(57) ABSTRACT

The invention relates to a radiation curable hot melt composition comprising: a) 20 to 100 wt. % of a radiation curable resin or a mixture of radiation curable resins having a viscosity in the range from 15 to 10,000 mPas in the temperature range from 40 to 150° C., b) 0 to 50 wt. % of a hydroxyfunctional resin or oligomer or a mixture of hydroxyfunctional resins or oligomers, c) 0 to 10 wt. % of a photoinitiator, d) 0 to 50 wt. % of fillers and/or additives, and e) 0 to 40 wt. % of pigment, wherein the total amount of components a) to e) adds up to 100 wt. %. The invention further relates to a process for the coating of a substrate with such radiation curable hot melt composition. In this process the composition is heated to a temperature in the range from 40 to 150° C., is applied to the substrate, and then the coated substrate is exposed to electromagnetic radiation having a wavelength λ≦500 nm.

This application claims priority of European Patent Application No. 99203431.4, filed on Oct. 19, 1999.

The present invention relates to a radiation curable composition that is suited in particular for use on heat sensitive substrates, like cellulose-containing or plastic substrates. Further, these compositions are highly suitable for the application of a coating on a substrate at high application speeds

### BACKGROUND OF THE INVENTION

Traditionally, UV curable lacquers have been used to achieve high performance coating systems for heat sensitive substrates. One of the drawbacks of these systems is their relatively high viscosity at room temperature. As a consequence, solvents or reactive monomers, also known as reactive diluents, have to be used to reduce the viscosity of the coating composition in order to get good flow and leveling at room temperature to achieve the desired smooth coated surface.

If a solvent is used to adjust the viscosity to obtain the desired flow and leveling properties of the coating composition, it must be removed from or driven out of the coating layer before or during the curing of the coating. In the past, the solvents were simply driven off and permitted to escape into the atmosphere. The emission of most organic solvents contributes to the VOC level of the coating composition. The VOC level is restricted by present day legislation. Such restrictions are expected to be tightened in the near future. Several recycling systems for solvents have been proposed, but such systems and their operation are capital intensive.

The use of reactive diluents prevents VOC emission, as they are incorporated into the final film. However, they are known for their skin irritant and sensitizing properties. Further, these components often have a bad odour and are suspect in view of their toxic properties.

A further problem when coating porous substrates, e.g. wood, is the penetration of the reactive monomers into the pores of the substrate. This is a drawback in particular when the coating is cured by radiation. Since the radiation does not reach these areas, uncured coating material in the pores of the substrate is the result. This can give health, safety, and environmental problems, e.g., when the substrate is cut or sanded. Release of free monomers from porous panels is known to occur even years after the lacquer has been applied.

In particular low-molecular weight material, viz. monomers and oligomers that are used as reactive diluents, gives the biggest problem with penetration in these porous substrates. Well-known acrylic diluents, e.g., tripropylene glycol diacrylate (TPGDA), hexanediol diacrylate (HDDA), acrylated penta-erythritolethoxylate (PTTA), and hydroxyethyl methacrylate (HEMA) are skin irritants and sensitizing and will never react if they are not reached by the UV light.

One way to overcome the problems associated with the use of solvents or reactive diluents in these coating compositions is the use of a thermally curable powder coating. However, this technology has some drawbacks, in particular when used for coating substrates like wood or plastic. The poor conductivity of these substrates makes it often difficult to apply a film of even thickness in an efficient process. It is only possible to obtain a film of even thickness at a relatively large layer thickness. This in turn means a higher consumption of coating material, which makes this process rather expensive. Further, the application of a powder coating to these substrates is often associated with dust problems due to the nature of the coating material. It is also difficult to get a good leveling of the coating, since the temperature of the coating cannot be raised to the desired degree (above 100° C., a temperature range needed to get a good flow of the coating over the substrate) in view of the heat-sensitive nature of the substrate. The high temperature (above 140° C.) needed to cure thermally curable powder coating compositions presents a further drawback of this type of coating material. For plastic substrates at these high temperatures often deformation of the substrate is observed. For wooden substrates at this higher temperature degassing of moisture and/or other volatile compounds and migration of natural wood resins to the surface of the substrate are observed. This will result in a poor adhesion of any coating or finish that is applied to the surface.

Further, with these thermally curable powder coating compositions it is not possible to apply a coating to a substrate at a high application speed, since the coating has to be heated in a first step to obtain a good flow over the substrate and heated further in a second step to initiate curing of the coating.

In U.S. Pat. No. 5,824,373 a powder coating system is disclosed to overcome the problems associated with a high curing temperature of a thermally curable powder coating composition. In this patent it is shown that powder coating compositions can be cured at a lower temperature by using UV curable powder coatings. The superior performance of these coating compositions reported in this patent is related to the high-molecular weight resins that are used in these powder coating formulations. No reactive monomers or solvents are used, since the flow of the coating is controlled by melting the solid powder coating. However, this technology still has some of the drawbacks that were mentioned above for thermally curable powder coating compositions, in particular drawbacks not related to the curing temperature, like those associated with the poor conductivity of substrates. With these UV curable powder coating systems it is not possible to obtain a high application speed either.

Further, this technology is not suited for the coating of heat-sensitive substrates like wood or plastic, since the coating needs to be heated to a temperature above 90° C. to have sufficient flow.

From an application point of view, powder coating technology is also less attractive to manufacturers of coated substrates who are used to applying solvent borne coatings by using rollers, sprayers etc., since they have to invest in new equipment and technology to be able to handle, apply, and regenerate the powder coating.

From U.S. Pat. No. 4,990,364 hot melt coating compositions are known, which still show some of the drawbacks that are found for UV curable powder coating compositions, viz. the drawback of using relatively high temperatures to apply the coating to a substrate by melting the coating composition (>100° C.). This also makes these hot melt coating compositions less suited for use on heat sensitive substrates.

If such compositions were used for coating wooden substrates, further problems would be encountered that are connected to the degassing of wood, which for some types of wood can start at a temperature below the application temperature of the coating. As indicated above, high temperatures can also lead to the migration of natural wood resins to the surface of the substrate, which is not desirable.

Since the temperature of application of these coating compositions would be a compromise between the application viscosity of the composition and heat damage to the substrate, the application viscosity normally is not optimal.

In EP 608 891, U.S. Pat. No. 4,234,662, and U.S. Pat. No. 5,536,759 pressure sensitive adhesives are disclosed. These compositions can be cured by radiation. However they can not be used as coating compositions since they are tacky after radiation cure.

In WO 98/18868 a radiation hardenable solventless primer is disclosed that is used to improve the adhesion to flexible substrates. The primer compositions that are disclosed all comprise more than 50 wt. % of an hydroxyfunctional resin or oligomer. It was found that these compositions, when applied to a substrate and cured using UV radiationonly, provides a tacky coating. Such compositions can thus not be used as a tack-free topcoat.

### SUMMARY OF THE INVENTION

The composition according to the present invention overcomes the drawbacks of the above-mentioned coating compositions that are known in the art. In particular the present invention provides compositions that can be used as coating compositions that are non-tacky after radiation curing.

The present invention concerns a radiation curable hot melt composition that can be cured by radiation only to a non-tacky coating, said composition comprising:
a) 20 to 100 wt. % of a radiation curable resin or a mixture of radiation curable resins having a viscosity in the range from 15 to 10,000 mPas in the temperature range from 40 to 150° C.,
b) 0 to 50 wt. % of a hydroxyfunctional resin or oligomer or a mixture of hydroxyfunctional resins or oligomers
c) 0 to 10 wt. % of a photoinitiator
d) 0 to 50 wt. % of fillers and/or additives, and
e) 0 to 40 wt. % of pigment,
wherein the total amount of components a) to e) adds up to 100 wt. %.

The hot melt composition according to the present invention provides a number of advantages over coating or putty compositions that are known in the art:
it contains no solvent, so the composition is VOC-free
skin irritating monomers can be avoided, it has less or no bad odour, unreacted monomers in porous substrates can be avoided and has less extractables,
since it can be applied as a “conventional” solvent-containing coating, no problems are encountered if the substrate has poor conductivity,
the film thickness can be controlled easily,
properties like adhesion, abrasion, resistance after abrasion, and chemical resistance are highly improved,
it is possible to apply the composition at high speed.

### DETAILED DESCRIPTION OF THE INVENTION

Within the framework of the present invention, a radiation curable hot melt composition is a hot melt composition which is cured by using electromagnetic radiation having a wavelength λ≦500 nm. Examples of such radiation are, e.g., UV radiation or electron beam radiation.

Within the framework of the present invention, a heat sensitive substrate is a substrate that shows deformation, structural changes, discolouration, or other thermal damage when heated to a temperature above 100° C., more in particular to a temperature in the range of 100 to 200° C.

It was found that the hot melt composition according to the present invention is suited in particular to be used on heat-sensitive substrates. Normally, the application temperature of the hot melt coating composition is in the range from 40 to 150° C. The preferred temperature range for application of the coating composition to heat-sensitive substrates is from 40 to 100° C., more preferably from 50 to 90° C. If the composition is used as a coating composition, optimum properties are obtained if the viscosity of the coating composition is in the range from 15 to 4,000 mPas, more preferably from 15 to 3,000 mPas, in the above-indicated temperature ranges. If the composition is used as a putty composition, optimum properties are obtained if the viscosity of the putty composition is in the range from 3,000 to 10,000 mPas, more preferably from 4,000 to 9,000 mPas, in the above-indicated temperature ranges.

The viscosity of the composition at the application temperature should be selected in accordance with the way the composition is applied to the substrate. For example, for spray application the viscosity should be lower than for roller application.

In principle any radiation curable resin or mixtures of resins can be used in the hot melt composition according to the present invention. These resins are present in an amount of 20 to 100 wt. % of the composition. Preferably, the resin is present in an amount of 30 to 90 wt. %, more preferred is an amount of 40to90 wt. %.

Polyesteracrylate resins were found to be very suitable for use in the hot melt coating composition according to the present invention. Examples of suitable commercially available polyesteracrylate resins are: Crodamer UVP-215, Crodamer UVP-220 (both ex Croda), Genomer 3302, Genomer 3316 (both ex Rahn), Laromer PE 44F (ex BASF), Ebecryl 800, Ebecryl 810 (both ex UCB), Viaktin 5979, Viaktin VTE 5969, and Viaktin 6164 (100%) (all ex Vianova). Very promising results are found if the composition comprises at least 40 wt. % of a polyesteracrylate resin.

Epoxyacrylate resins can also be used in the hot melt coating composition according to the present invention. Examples of commercially available epoxyacrylate resins are: Crodamer UVE-107 (100%), Crodamer UVE-130 (both ex Croda) Genomer 2254, Genomer 2258, Genomer 2260, Genomer 2263 (all ex Rahn), CN 104 (ex Cray Valley), and Ebecryl 3500 (ex UCB).

Polyetheracrylate resins can also be used in the hot melt coating composition according to the present invention. Examples of commercially available polyetheracrylate resins are: Genomer 3456 (ex Rahn), Laromer P033F (ex BASF), Viaktin 5968, Viaktin 5978, and Viaktin VTE 6154 (all ex Vianova).

Urethaneacrylate resins can also be used in the hot melt coating composition according to the present invention. Examples of commercially available urethaneacrylate resins are: CN 934, CN 976, CN 981 (all ex Cray Valley), Ebecryl 210, Ebecryl 2000, Ebecryl 8800 (all ex UCB), Genomer 4258, Genomer 4652, and Genomer 4675 (all ex Rahn).

Another example of radiation curable resins that can be used in the hot melt composition according to the present invention are cationic UV curable resins, such as cycloaliphatic epoxide resins like Uvacure 1500, Uvacure 1501, Uvacure 1502, Uvacure 1530, Uvacure 1531, Uvacure 1532, Uvacure 1533, and Uvacure 1534 (all ex. UCB Chemicals), Cyracure UVR-6100, Cyracure UVR-6105, Cyracure UVR-6110, and Cyracure UVR-6128, (all ex. Union Carbide), or SarCat K126 (ex. Sartomer), acrylate modified cycloaliphatic epoxides, caprolactone-based resins like SR 495 (=caprolactone acrylate ex. Sartomer), Tone 0201, Tone 0301, Tone 0305, Tone 0310, (all caprolactone triol ex. Union Carbide), aliphatic urethane divinyl ether, aromatic vinyl ether oligomer, bis-maleimide, diglycidyl ether of bisphenol A or other glycols, hydroxy-functional acrylic monomer, hydroxy-functional epoxide resin, epoxidised linseed-oil, epoxidised polybutadiene, glycidyl ester or partially acrylated bisphenol A epoxy resin, or trimethylolpropaneoxetane (UVR 6000, ex. Union Carbide).

Other radiation curable compounds that are suitable to be used in the hot melt-containing composition according to the present invention are, e.g., vinyl ether-containing compounds, unsaturated polyester resins, acrylated polyetherpolyol compounds, (meth)acrylated epoxidised oils, (meth)acrylated hyperbranched polyesters, silicon acrylates, maleimide functional compounds, unsaturated imide resins, compounds suitable for photo-induced cationic curing, or mixtures thereof.

It is possible to use in the compositions according to the present invention a radiation curable mixture of (a) photo-induced radical curing resin(s) and (a) photo-induced cationic curing resin(s). Such systems which are also called hybrid systems comprise, for example, acrylic oligomers and vinyl ethers (as an example of a photo-induced radical curing resin and a photo-induced cationic curing resin) and radical and cationic photoinitiators. In principle all possible combinations of photo-induced radical curing resins and photo-induced cationic curing resins can be used in such hybrid systems.

It was found that coatings or putties with very good properties are obtained if the radiation curable composition comprises a resin or a mixture of resins with a T_{g} below 0° C., preferably below −20° C. Optimum properties were found if the resin or the mixture of resins has a T_{g} in the range of −70° C. to −20° C.

The composition according to the present invention can also comprise a hydroxyfunctional resin or oligomer or a mixture of hydroxyfunctional resins or oligomers. It was found that if the level of these type of resins in the coating composition is too high (above 50 wt. %), the coating is still tacky after radiation cure. Examples of hydroxy functional resins that can be used are hydroxy functional (poly)urethane resins and hydroxy functional (poly)acrylate resins. Normally these type of resins are added to the coating composition to have a coating with a further build-in chemical functionality. The amount of this type of resin can be in the range from 0-50 wt. %, preferably 0-30 wt. %, more preferably 0-10 wt. %, calculated on the total weight of the composition.

Further, the composition can comprise a photoinitiator or a mixture of photo-initiators. Examples of suitable photoinitiators that can be used in the radiation curable composition according to the present invention are benzoin, benzoin ethers, benzilketals, α,α-dialkoxyacetophenones, α-hydroxyalkylphenones, α-aminoalkylphenones, acylphosphine oxides, benzophenone, thioxanthones, 1,2-diketones, and mixtures thereof; It is also possible to use copolymerisable bimolecular photoinitiators or maleimide functional compounds. Co-initiators such as amine based co-initiators can also be present in the radiation curable coating composition. Examples of suitable commercially available photo-initiators are: Esacure KIP 100F and Esacure KIP 150 (both ex Lamberti), Genocure BDK and Velsicure BTF (both ex Rahn), Speedcure EDB, Speedcure ITX, Speedcure BKL, and Speedcure DETX (all ex Lambson), Cyracure UVI-6990, Cyracure UVI-6974, Cyracure UVI-6976, Cyracure UVI-6992 (all ex Union Carbide), and CGI-901, Irgacure 184, Irgacure 500, Irgacure 1000, and Darocur 1173 (all ex Ciba Chemicals).

However, the presence of a photoinitiator is not necessary. In general, when electron beam radiation is used to cure the composition, it is not necessary to add a photoinitiator. When UV radiation is used, in general a photoinitiator is added.

Although the total amount of photoinitiator in the composition is not critical, it should be sufficient to achieve acceptable curing of the coating when it is irradiated. However, the amount should not be so large that it affects the properties of the cured composition in a negative way. In general, the composition should comprise between 0 and 10 wt. % of photoinitiator, calculated on the total weight of the composition.

The composition can also contain one or more fillers or additives. Fillers can be any fillers known to those skilled in the art, e.g., barium sulphate, calcium sulphate, calcium carbonate, silicas or silicates (such as talc, feldspar, and china clay). Additives such as stabilizers, antioxidants, leveling agents, antisettling agents, matting agents, rheology modifiers, surface-active agents, amine synergists, waxes, or adhesion promoters can also be added. In general, the hot melt coating composition according to the present invention comprises 0 to 50 wt. % of fillers and/or additives, calculated on the total weight of the coating composition.

The composition according to the present invention can also contain one or more pigments. Pigments known to those skilled in the art can be used in the radiation curable composition according to the present invention. However, care should be taken that the pigment does not show a too high absorption of the radiation used to cure the composition. In general, the hot melt composition according to the present invention comprises 0 to 40 wt. % of pigment, calculated on the total weight of the coating composition.

In addition to the compounds mentioned above, the radiation curable composition according to the present invention can also comprise monomers or reactive diluents, e.g., to lower the viscosity of the composition. However, the amount of such compounds should be as low as possible.

The process for the preparation of the radiation curable hot melt composition according to the present invention is not critical. The components can be added in any arbitrary sequence. Normally, the components are mixed until a homogeneous mixture is obtained. The mixing can be done in air. Care should be taken that during the mixing of the components the temperature does not become so high as to cause degradation of any of the components. Needless to say, the mixing should be performed in the absence of any radiation that could initiate curing of the coating.

The present invention also relates to a process for the coating of a substrate by the application of a radiation curable hot melt composition. This process comprises the steps of:

1) providing a curable hot melt composition comprising
a) 20 to 100 wt. % of a radiation curable resin or a mixture of radiation curable resins having a viscosity in the range from 15 to 10,000 mPas in the temperature range from 40 to 150° C.,
b) 0 to 50 wt. % of a hydroxyfunctional resin or oligomer or a mixture of hydroxyfunctional resins or oligomers,
c) 0 to 10 wt. % of a photoinitiator,
d) 0 to 50 wt. % of fillers and/or additives, and
e) 0 to 40 wt. % of pigment,
wherein the total amount of components a) to e) adds up to 100 wt. %.

2) heating said hot melt composition to a temperature in the range from 40 to 150° C.,

3) applying said hot melt coating composition to the substrate in the form of a coating or thin film, and

4) curing said hot melt by exposing the coated substrate to electromagnetic radiation having a wavelength λ≦500 nm.

Optionally, to get a better performance of this process, the surface of the substrate is heated before, during and/or after the application of the hot melt coating composition. This is particularly advantageous in those processes where high application speeds are employed. The heating can be performed by using inductive heating, a hot air stream or by infrared light. Plastic substrates can be pretreated by corona, flame treatment, plasma, or a chemical treatment to improve the adhesion of the hot melt coating composition to the substrate.

The process described above is suited for coating a substrate using coating compositions or putty compositions.

The preferred temperature range for the application of the coating composition to heat-sensitive substrates is from 40 to 100° C., more preferably from 50 to 90° C. If the composition is used as a coating composition, optimum properties are obtained if the viscosity of the coating composition is in the range from 15 to 4,000 mPas, more preferably from 15 to 3,000 mPas, in the above-indicated temperature ranges. If the composition is used as a putty composition, optimum properties are obtained if the viscosity of the putty composition is in the range from 3,000 to 10,000 mPas, more preferably from 4,000 to 9,000 mPas, in the above-indicated temperature ranges.

Equipment known to those skilled in the art can be used to apply the heated hot melt coating. E.g., when a flat substrate is coated, the coating can be applied by using heated rollers. For these and other substrates it is also possible to use a heated spraygun or a heated curtain coater to apply the heated hot melt coating. It is also possible to heat the composition in a storage tank or vessel and/or to heat the composition in the hose that transports the composition to an application apparatus and/or in the application apparatus itself. Heating can be performed by using direct or indirect heating, e.g., by using infrared radiation. Die applicators can be used for higher viscosities, for example for coil coatings.

In this process preference is given to the use of hot melt compositions that have a viscosity in the range from 15 to 10,000 mPas at the application temperature (40 to 150° C.). The viscosity of the composition at the application temperature should be selected in accordance with the way the composition is applied to the substrate. For example, for spray application the viscosity should be lower than for roller application.

It was found that by using these hot melt compositions excellent flow and levelling of the coating material are obtained. Further, it was found that the thickness of the coated film can be controlled easily. A film with a thickness of 5 μm can be applied without any special precautions being taken. On the other hand, it is also possible to apply a film with a thickness of 250 μm in one layer without sagging and with optimum leveling properties.

The coating on the thus obtained coated substrates has a very high abrasion resistance on the one hand and a very high flexibility on the other.

The hot melt composition according to the present invention can be used as a primer, surfacer, filler, sealer, base coat and/or top coat. To obtain optimum properties of the coated substrate with respect to abrasion resistance, stain resistance, flexibility, and adhesion, each coating layer is applied in an amount of 5 to 40 g/m².

If the substrate is parquet flooring, optimum results are found if the coating composition according to the present invention is applied in one or two layers as a base coat at 25 to 35 g/m², and as a top coat at 5 to 15 g/m².

If the substrate is furniture veneer, optimum results are found if the coating composition according to the present invention is applied in one or two layers as a base coat at 25 to 35 g/m², and as a top coat at 5 to 20 g/m².

If the substrate is PVC flooring, optimum results are found if the coating composition according to the present invention is applied in one layer as a base coat at 5 to 20 g/m². For PVC flooring it is also possible to add an additional layer as a base coat or a top coat. However, no improvement of properties is achieved by the addition of these extra layers.

The hot melt compositions according to the present invention are particularly suited to be applied on heat-sensitive substrates. These substrates include cellulose-containing or plastic substrates. Examples of heat-sensitive substrates are wooden panels, veneer, fibre boards, plastic parts, PVC flooring panels, and electric circuit boards.

The hot melt compositions according to the present invention are also very suited to be applied at high speed. For example, they are very suited to be used for the coating at high speed of flat panels of wood, plastic or steel.

The invention will be elucidated with reference to the following examples. These are intended to illustrate the invention but are not to be construed as limiting in any manner the scope thereof.

### EXAMPLES

Measurement Method for the Viscosity

The viscosity of the compositions was measured at 60° C. at 10 s⁻¹ in a Stresstech Rheologica AB cone-plate viscometer, equipped with a cone (diameter of 40 mm, 1° angle) and an ETC cell for high-temperature measurements.

Measurement Method for T_{g}

The T_{g} of the radiation curable resin(s) was measured for 5 to 10 mg samples in a Perkin Elmer DSC Pyris 1, at a heating rate of 10° C./min.

Different coating formulations according to the present invention were prepared and applied to different substrates. The thus obtained coated substrates were tested for their abrasion resistance, chemical resistance, extractable monomers, and flexibility of the coating layer. To simulate conventional UV lacquer compositions, some formulations were diluted with conventional/state of the art diluents to application viscosity and applied to the substrates at room temperature.

In Table 1 an overview is presented of the composition of the different formulations. For the preparation of these compositions the following components were used:

| | |
|---|---|
| Crodamer UVP 215/220 | both polyesteracrylate binders |
| CY 179 | a cycloaliphatic epoxy binder |
| Cyracure UVR 6000 | 3-ethyl-3-hydroxymethyl-oxetane binder |
| Ebecryl 8800 | an aliphatic urethane acrylate binder |
| Gasil AQ 75N | a filler (amorphous silica) |
| Genocure MBF | a methylbenzoylformate photoinitiator |
| Laromer PAB | a polyesteracrylate binder |
| Laromer PO43F | a polyetheracrylate binder |
| Plastorit Super | a filler |
| Setal UPB | an unsaturated polyester binder |
| Siokal FF20 | a filler |
| Speedcure BEM | a benzophenone photoinitiator |
| Tone 305 | a caprolactone triol binder |
| UV 9380C | a photoinitiator |
| Viaktin 6164 | a polyesteracrylate binder |

The hot melt coating formulations were applied to different substrates, e.g., parquet flooring (oak and beech), veneer, and PVC material. Before the application of the coating, the substrates were preheated to a temperature between 50 to 80° C. The hot melt coating compositions were applied to flat substrates using a roller coater at a temperature between 60 to 80° C. at 5 to 30 g/m². After the application of the hot melt coating, the coated substrates were transported through an oven to get a better flow and a smoother surface. Then the coated substrates were mounted on a drive belt and passed under an 80 W/cm Hg Lamp at a speed of 5 m/min.

TABLE 1
Radiation curable hot melt coating formulations (in % by weight)

| | Formulation | | | | | | | | |
|---|---|---|---|---|---|---|---|---|---|
| Compound | 1 | 2 | 3 | 4 | 5 | 6 | 7 | 8 | 9 |
| Crodamer UVP 220 | | | | | | 78.26 | | | |
| Crodamer UVP 215 | | | | | | | 86.96 | | |
| CY-179 | | | | | | | | 84.16 | 76.51 |
| Cyracure UVR 6000 | | | | | | | | | 9.09 |
| Ebecryl 8800 | | | | | | 8.70 | | | |
| Gasil AQ 75N | | | 7.08 | 10.26 | 13.33 | 8.70 | 8.70 | | |
| Genocure MBF | 1.75 | 1.75 | 2.21 | 2.14 | 1.67 | 2.17 | 2.17 | | |
| Laromer PAB | | 61.40 | 70.80 | 68.37 | 66.66 | | | | |
| Laromer PO43F | | | 17.70 | 17.09 | 16.67 | | | | |
| Plastorit Super | 4.39 | 4.39 | | | | | | | |
| Setal UPB | | 26.32 | | | | | | | |
| Siokal FF20 | 4.39 | 4.39 | | | | | | | |
| Speedcure BEM | 1.75 | 1.75 | 2.21 | 2.14 | 1.67 | 2.17 | 2.17 | | |
| Tone 305 | | | | | | | | 13.86 | 12.60 |
| UV 9380C | | | | | | | | 1.980 | 1.80 |
| Viaktin 6164 | 87.72 | | | | | | | | |
| Viscosity (mPas) | 1,210 | 1,210 | 804 | 1,100 | 2,330 | 3,690 | 2,580 | 48 | 35 |
| T_{g} (° C.) | −47 | −46 | −55 | −55 | −55 | −48 | −44 | | |

### Example 1

In accordance with the procedure described above, a base coat was applied to a flooring panel at 60 g/m² in two steps by applying hot melt coating formulation 1. Formulation 3 was applied as a top coat at 10 g/m².

For comparison, formulation 1 was diluted with 30 wt. % of tripropylene glycol diacrylate (TPGDA) and formulation 3 with 50 wt. % of glycol diacrylate (TPGDA).

The abrasion resistance of the thus obtained samples was measured according to SIS (Swedish Industrial Standard) 923509.

The following results were found:

| Test sample | abrasion/100 revolutions |
|---|---|
| formulation 1 | 2.0 mg |
| formulation 3 | 3.0 mg |
| formulation 1 + 30% TPGDA | 3.5 mg |
| formulation 3 + 50% TPGDA | 4.5 mg |

The abrasion resistance of the coated panels was measured as the number of revolutions to wear through. The following results were found:

| | revolutions to |
|---|---|
| Test sample | wear through |
| Panel coated with formulation 1 base coat and | 7000 |
| formulation 3 top coat | |
| Panel coated with formulation 1 + 30% TPGDA base | 4000 |
| coat and formulation 3 + 50% TPGDA top coat | |

Further, for formulations 1 and 3 no extractable monomers were found in the coated substrate. For the formulations including TPGDA 8 mg/dm² of extractable monomers were found.

### Example 2

In accordance with the procedure described above, a base coat was applied to a PVC flooring at 10 g/m².

For comparison, formulation 6 was diluted with 40 wt. % of hexanediol diacrylate (HDDA) and applied at room temperature.

The flexibility of the coating was measured by bending the coated PVC substrate through 180°. For the substrate coated with formulation 6 no cracking was observed. For the substrate coated with the diluted formulation 6, cracks were observed in this test.

It was further found that the stain resistance of the PVC substrate coated with formulation 6 was much better than the stain resistance of the substrate coated with the diluted formulation. The results for these tests are given in Table 2 on a five points scale. 0 indicates very poor stain resistance, 5 indicates excellent stain resistance.

TABLE 2
Stain resistance

| Dye in | Formulation 6 | Formulation 6 + 40 wt. % HDDA |
|---|---|---|
| Water | 5.0 | 4.5 |
| Ethanol | 3.5 | 3.0 |
| White spirit | 5.0 | 4.0 |

### Example 3

The cationic curing coating compositions of examples 8 and 9 were applied to a substrate in accordance with the procedure described above. 2 hours after the curing of the coatings the pendulum hardness (König) of the coatings was measured using a standard test. A hardness of 210 and 217 s was found for the compositions of examples 8 and 9, respectively.

1. A radiation curable hot melt composition that can be cured by radiation only to a non-tacky coating, said composition comprising:
a) 20 to 100 wt. % of a radiation curable resin or a mixture of radiation curable resins having a viscosity in the range from 15 to 10,000 mPas in the temperature range from 40 to 150° C.,
b) 0 to 50 wt. % of a hydroxyfunctional resin or oligomer or a mixture of hydroxyfunctional resins or oligomers,
c) 0 to 10 wt. % of a photoinitiator,
d) 0 to 50 wt. % of fillers and/or additives, and
e) 0 to 40 wt. % of pigment,
wherein the total amount of components a) to e) adds up to 100 wt. %.

2. The radiation curable hot melt composition of claim 1, wherein the radiation curable resin or the mixture of radiation curable resins has a T_{g} below 0° C.

3. The radiation curable hot melt composition of claim 1, wherein the composition is a coating composition comprising a radiation curable resin or a mixture of radiation curable resins with a viscosity in the range from 15 to 4,000 mPas in the temperature range from 40 to 150° C.

4. The radiation curable hot melt composition of claim 1, wherein the composition is a putty composition comprising a radiation curable resin or a mixture of radiation curable resins with a viscosity in the range from 3,000 to 10,000 mPas in the temperature range from 40 to 150° C.

5. The radiation curable hot melt composition according to claim 1, wherein the composition comprises a polyesteracrylate resin.

6-10. (canceled)
